(19) United States
(12) Patent Application Publication
(10) Pub. No.: US 2013/0173309 A1
(43) Pub. Date: Jul. 4, 2013

(54) PRIVACY AWARENESS TOOL

(71) Applicant: Darren Dworkin, Los Angeles, CA (US)

(72) Inventor: Darren Dworkin, Los Angeles, CA (US)

(73) Assignee: CEDARS-SINAI MEDICAL CENTER, Los Angeles, CA (US)

(21) Appl. No.: 13/822,755

(22) PCT Filed: Nov. 11, 2011
(86) PCT No.: PCT/US11/60420

§ 371 Date: Mar. 13, 2013

Related U.S. Application Data
(60) Provisional application No. 61/418,738, filed on Dec. 1, 2010.

(51) Int. Cl. G06Q 50/22

(52) U.S. Cl. CPC G06Q 50/22; G06Q 10/0635
USPC 705/3; 705/2

(57) ABSTRACT

Systems and methods for applying sets of rules to data for providing useful information for review or action at an appropriate time. More specifically, embodiments of the present invention relate to applying rules to large data sets of audit information from clinical systems of one or more healthcare provider facilities to detect patterns of behaviors that may be of concern (e.g., potential privacy violations, objectivity concerns, fraudulent behavior, abnormal activity, etc.), and to address the behaviors through human or system review or action. The rules may be weighted, aggregated, and scored to facilitate the improved detection of patterns of certain behaviors occurring at one or more healthcare provider facilities.

### CROSS-REFERENCE TO RELATED APPLICATIONS

This application claims priority to U.S. Provisional Application No. 61/418,738 filed Dec. 1, 2010, which is hereby incorporated by reference in its entirety.

### FIELD OF THE INVENTION

The present invention relates to systems and methods for applying sets of rules to one or more data sets for providing useful information for review or action at an appropriate time. More specifically, the present invention relates to applying rules to large data sets of audit information from a healthcare provider facility's information systems to detect patterns of behaviors that may be of concern, and to address the behaviors through human or system review and/or action.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

Electronic medical records (EMR) data have become widely used by physicians, researchers, laboratories, hospitals, and other healthcare provider facilities. EMR data may include various data about patients including medical history data, test data, medication data, and the like. Further, healthcare provider facilities often utilize electronic data systems that track and store information relating to transactions or events that occur at the facility, including appointments, treatments, medications prescribed, tests, etc. As can be appreciated, this results in the generation and storage of very large sets of data relating to the operations of the healthcare provider facility.

### SUMMARY

In one embodiment, the invention includes a computer system for use in a healthcare provider facility setting. The computer system includes a rules storage module operative to store a set of rules configured to detect one or more predetermined behaviors of persons associated with the healthcare provider facility (e.g., employees, family members of employees, or patients); a rules application module operatively coupled to the rules storage module, and further operative to receive a set of audit data (e.g., from an EMR system) and apply the set of rules to the audit data to determine the presence or absence of the one or more predetermined behaviors; and a notification module operatively coupled to the rules application module and configured to automatically generate a notification (e.g., a textual message, a report, etc.) in response to receiving an indication from the rules application module that one or more of the predetermined behaviors is present.

In some embodiments, the computer system further includes a rules generation module coupled to the rules storage module configured to permit a user to generate the set of rules. The rules application module may be configured to weight individual rules differently depending on their importance or frequency of occurrence, and may also be configured to combine a plurality of rules to determine the presence or absence of a single predetermined behavior. The one or more predetermined behaviors comprise fraudulent behavior or behavior that may present privacy concerns, or other types of behaviors. In some embodiments, the rules application module is operative to apply the set of rules to the audit data to generate a score, and to compare the score with a predetermined threshold to determine the presence or absence of one or more of the predetermined behaviors. The audit data may include patient data, employee data, transaction or event data, and the like.

In another embodiment, the invention includes a method for monitoring behavior in a healthcare provider facility setting. The method may include storing a set of rules configured to detect one or more predetermined behaviors of persons associated with the healthcare provider facility; accessing a set of audit data; applying the set of rules to the audit data to determine the presence or absence of the one or more predetermined behaviors; and generating a notification in response to receiving an indication from the rules application module that one or more of the predetermined behaviors is present.

In some embodiments, the method may include generating the set of rules dependent on input received from a user, weighing individual rules differently depending on their importance or frequency of occurrence, and/or combining a plurality of rules to determine the presence or absence of a single predetermined behavior. The method may also include applying the set of rules to the audit data to generate a score, and comparing the score with a predetermined threshold to determine the presence or absence of one or more of the predetermined behaviors. The persons associated with the healthcare provider facility may include employees, family members of employees, patients, etc.

In another embodiment, the invention includes a computer readable medium having stored thereon computer-executable instructions for performing a procedure to detect one or more predetermined behaviors of persons associated with a healthcare provider facility, the procedure comprising: storing a set of rules configured to detect the one or more predetermined behaviors; accessing a set of audit data; applying the set of rules to the audit data to determine the presence or absence of the one or more predetermined behaviors; and generating a notification in response to receiving an indication from the rules application module that one or more of the predetermined behaviors is present.

### BRIEF DESCRIPTION OF THE DRAWINGS

Exemplary embodiments are illustrated in the referenced figures. It is intended that the embodiments and figures disclosed herein are to be considered illustrative rather than restrictive.

FIG. 1 depicts a block diagram of a privacy awareness tool according to an embodiment of the present invention.

FIG. 2 depicts a flow chart of an exemplary process for implementing a privacy awareness tool according to an embodiment of the present invention.

FIG. 3 depicts a diagram of a hardware environment and an operating environment in which one or more computing devices associated with the privacy awareness tool may be implemented.

### DESCRIPTION OF THE INVENTION

One skilled in the art will recognize many methods, systems, and materials similar or equivalent to those described herein, which could be used in the practice of the present invention. Indeed, the present invention is in no way limited to the methods, systems, and materials described.

Embodiments of the present invention relate to systems and methods for applying sets of rules to data for providing useful information for review or action at an appropriate time. More specifically, the present invention relates to applying rules to large data sets of audit information from a healthcare provider facility's information systems to detect patterns of behaviors that may be of concern (e.g., potential privacy violations, fraudulent behavior, abnormal activity, objectivity concerns, etc.), and to address the behaviors through human or system review or action. Embodiments of the invention may be operative to apply the rules to the large sets of data as the data is being generated and updated, such that the useful information relating to the patterns of behaviors may be identified rapidly.

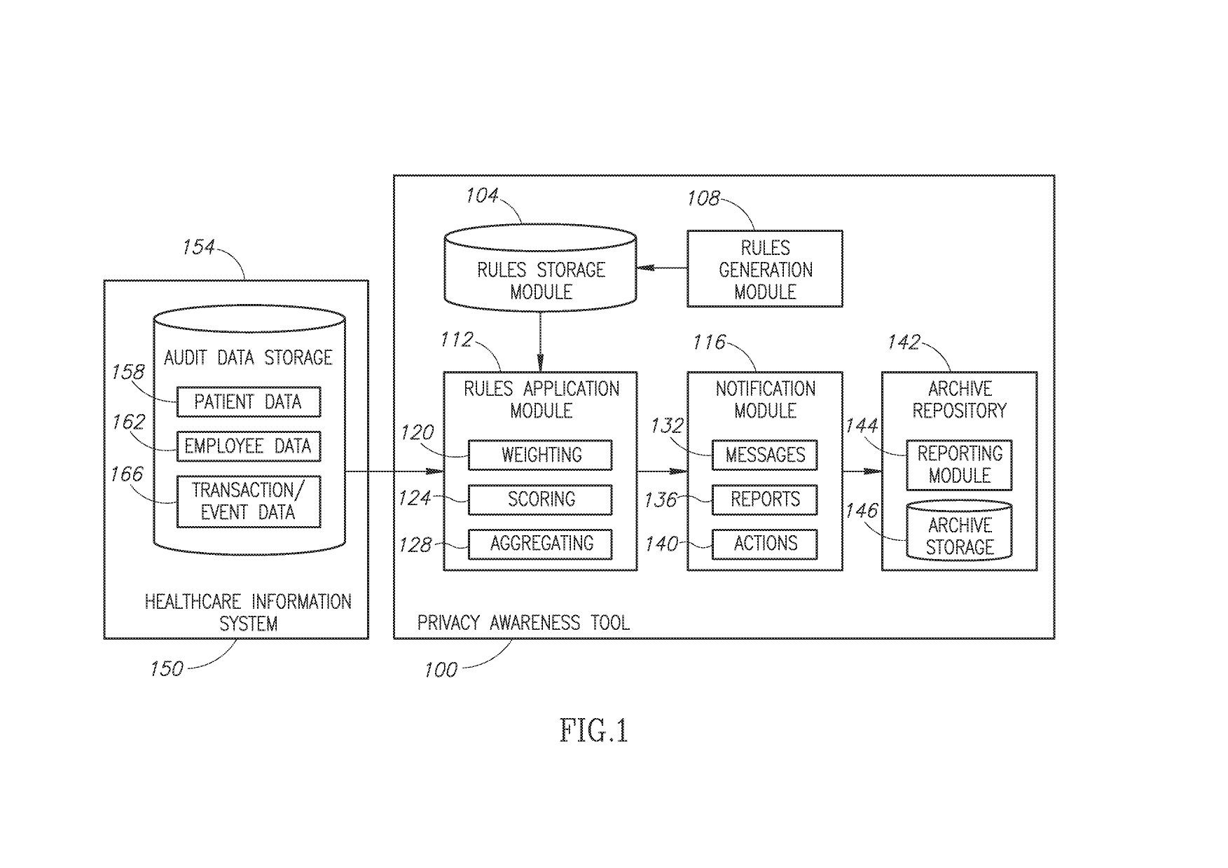

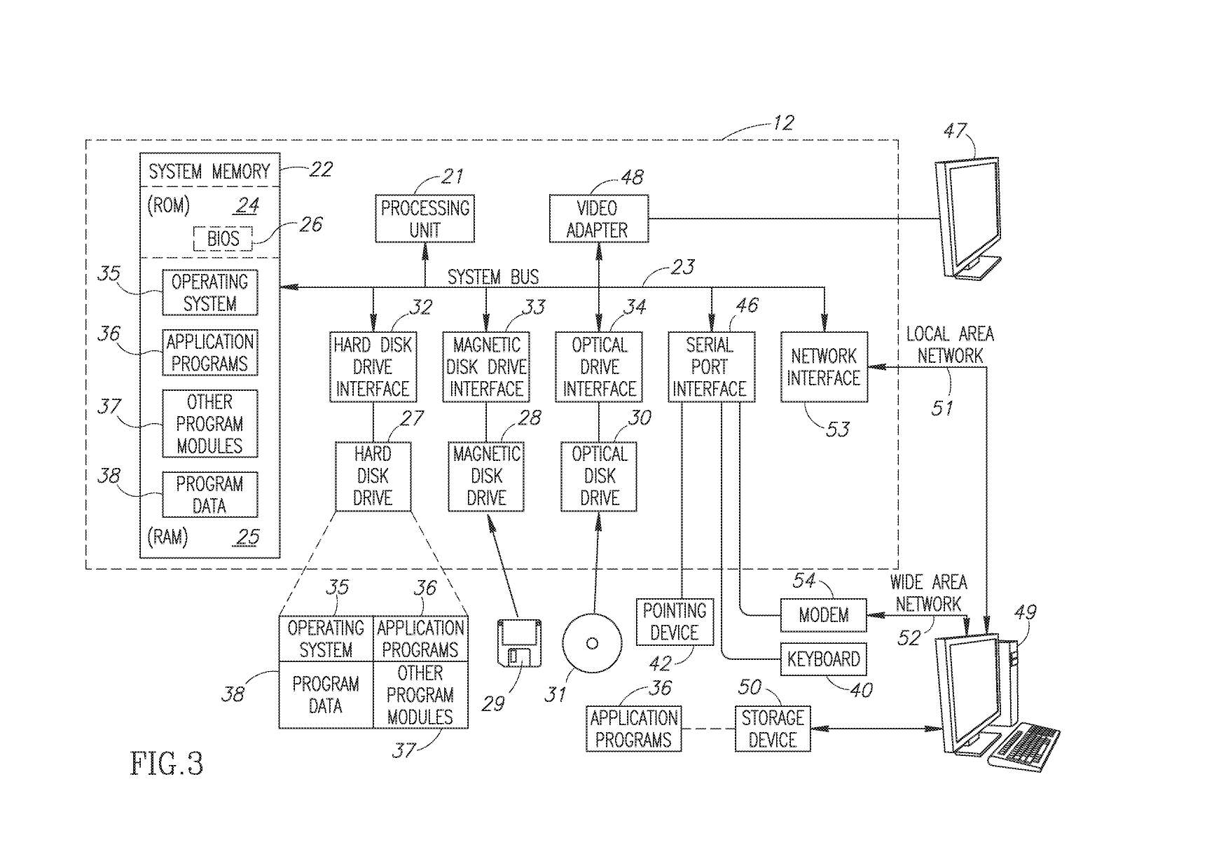

FIG. 1 depicts a block diagram of a privacy awareness tool 100 (or “system”) according to an embodiment of the present invention. A diagram of a hardware environment and an operating environment in which the privacy awareness tool 100 may be implemented is shown in FIG. 3. As shown in FIG. 1, the privacy awareness tool 100 utilizes audit data 154 that may be accessed from one or more healthcare information systems 150 such as an electronic medical record (EMR) system of a healthcare provider facility (or multiple related or unrelated facilities). The audit data 154 may include various types of patient data 158 including names, contact information, medical histories, medications, and the like. The audit data 154 may also include employee data 162 relating to employees of the healthcare provider facility, such as names, contact information, titles, departments, work histories, family members, and the like. Further, the audit data 154 may comprise transaction and/or event data 166 including information about the operations of the facility, such as patients' appointments, diagnoses, prescribed medications, tests ordered or performed, treatments, or other information routinely collected by a healthcare facility's EMS system.

The privacy awareness tool 100 also includes a rules generation module 108 configured to allow a user to create a set of rules that may be stored in a rules storage module 104. The rules generation module 108 may include an interface (e.g., GUI, keyboard, monitor, etc.) that allows it to receive commands/instructions from the user so that rules may be generated.

The privacy awareness tool 100 also includes a rules application module 112 configured to apply the established set of rules to the set of audit data 154 to monitor for and detect certain behaviors or patterns of behaviors that may be of concern. Examples of such rules and behaviors are provided below. Each of the rules may be weighted according to certain criteria, such as importance and frequency of occurrence. For example, a single violation of a particular rule in one month may be substantially less significant than a violation of the same rule five times in one month. Further, multiple rules may be combined together such that more weight is assigned to a violation of a combination of rules than would be assigned to a violation of each of the rules individually. In this regard, the privacy awareness tool 100 may be able to detect patterns of behaviors that would otherwise go unnoticed.

The set of rules may be weighted 120, aggregated 128, and scored 124 to identify when a particular behavior may be present. As an example, thresholds may be set dependent on the type of behavior being monitored and the level of confidence (or “risk”) preferred before a review of the behavior is triggered. Then, scores resulting from the application of the weighted rules to the audit data by the rules application module 112 may be compared against the thresholds to detect certain behaviors with a preferred level of confidence. The thresholds may be adjusted periodically as desired so that the privacy awareness tool 100 is more or less sensitive when detecting the behaviors.

In the event the rules application module 112 determines that a predetermined behavior has been detected, it may provide notice to a notification module 116. The notification module 116 may be operative to trigger a notification or alert to a human user or to otherwise initiate a review or other action. For example, the notification module 116 may automatically send a message 132 (e.g., email, text message, voicemail, etc.) to a user indicating a potential behavior of concern was detected, and may also provide a report 136 including information relating to the data relied upon in making the determination. The notification module 116 may also automatically initiate other actions 140, for example, modifying one or more of the rules, etc.

In some embodiments, the privacy awareness tool 100 also includes an archive repository 142 that is operative to collect data from the notification module 116 and store it in an archive storage module 146. The archive repository 142 is operative to aggregate all the messages, reports, and actions, and to provide an opportunity for users to perceive a holistic view of the collected information so that patterns may be identified. The archive repository 142 also includes a reporting module 144 that is operative to produce “industry standard” reports that show the detail of privacy auditing an organization is undertaking. The reporting module 144 may also produce incident or case reports to format the information needed to show and track data as needed for healthcare regulatory bodies. Further, the archive repository 142 may be operative to store a detailed copy of all the information related to any situation requiring actions as defined by the notification module 116.

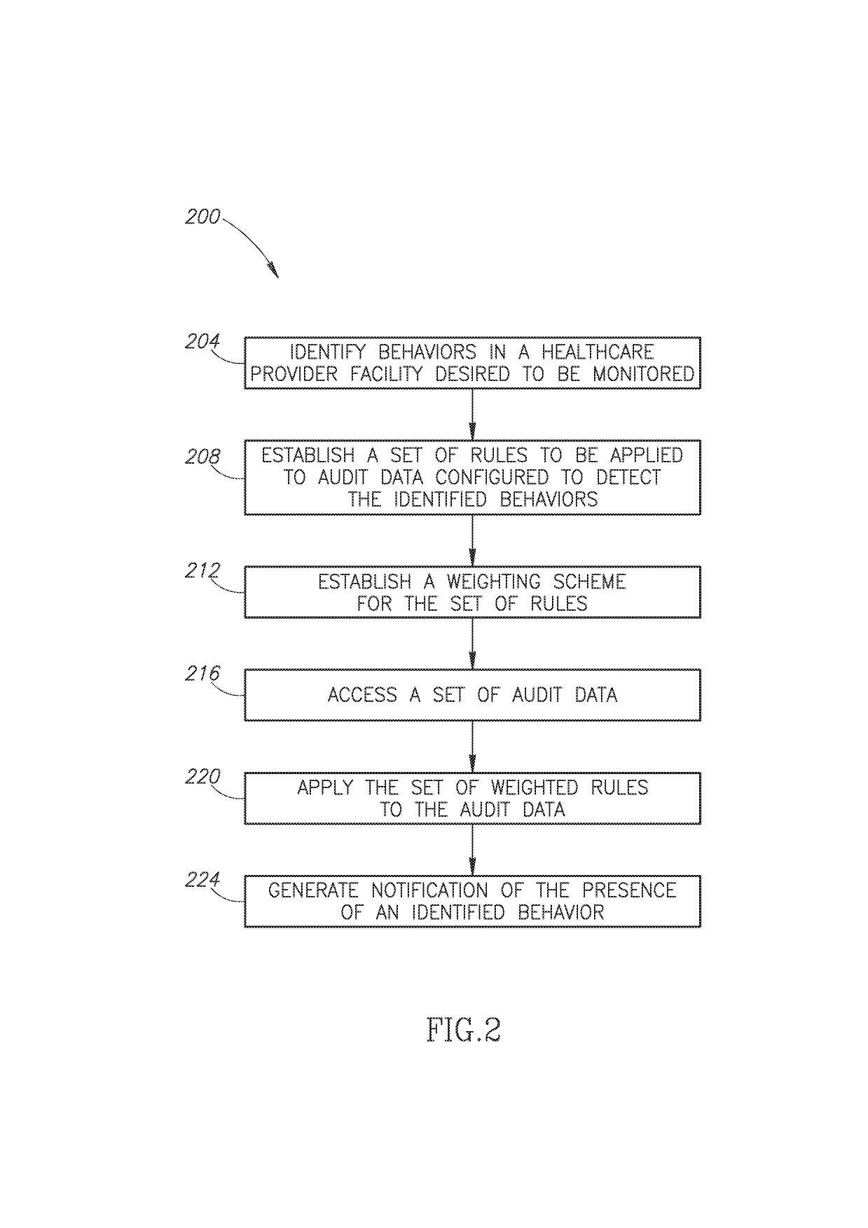

FIG. 2 depicts a flow chart of an exemplary process 200 for implementing a privacy awareness tool (e.g., the privacy awareness tool 100 of FIG. 1) according to an embodiment of the present invention. The process 200 begins by identifying one or more behaviors that may occur in a healthcare provider facility that are desired to be monitored, block 204. As noted above, such behaviors may include potential privacy violations, fraudulent behavior, abnormal activity, increased liability situations, potential compromised objective care situations, etc.

Next, a set of rules may be established (e.g., using the rules generation module 108) to be applied to audit data that is accessible from a healthcare provider facility's data systems, block 208. As discussed above, the audit data may include patient data, employee data, transaction and event data, and the like. The rules may then be weighted according to various criteria, block 212. The audit data may then be accessed and the rules may be applied to the audit data as described above, blocks 216 and 220. Further, any violations of a rule or set of rules that exceeds a predetermined threshold may be escalated and reported to a human user or another system for further review and/or action, block 224. As discussed above, the violation of a rule or a set of rules is indicative of the presence of a particular behavior that is desired to be monitored.

As can be appreciated, the set of rules may be applied against the audit data periodically (e.g., once per month, once per day, etc.) or substantially continuously as the data is generated so that results information may be available as needed. This feature may be desirable since the data sets being analyzed may be very large, such that the time and resources required to manually review them would be prohibitive.

Three examples of situations wherein embodiments of the privacy awareness tool 100 may be advantageous are provided below. It should be appreciated that these examples are provided for explanatory purposes, and in no way are they to be construed as being limiting to the methods, systems, and materials described herein.

### Example 1

### Detecting Irregular Treatments

One example of behaviors that may be monitored using the privacy awareness tool 100 is the detection of healthcare providers treating individuals outside of their expertise (e.g., a cardiologist seeing patients for brain disorders). Generally, the privacy awareness tool 100 may include rules established to identify when a healthcare provider sees a patient outside of his or her specialty. Various types of information available from the healthcare provider facility's clinical systems may be used to detect abnormal activity. For example, for obstetricians, the sex of their patients may be evaluated to determine whether the physician has examined a number of male patients, which may be an indication of abnormal activity.

Further, as discussed above, the frequency of such occurrences may be scored and weighted to better detect certain behaviors. Continuing with the obstetricians example, the privacy awareness tool 100 may be configured to assign relatively little weight when an obstetrician treats or prescribes medication to a single male patient, but may assign considerably more weight when an obstetrician treats or prescribes medications to multiple male patients within a relatively short time period.

If the activity of a healthcare provider evaluated by the privacy awareness tool 100 is at a level to cause a determination that a certain monitored behavior has occurred, the privacy awareness tool 100 may then report the activity for further review or action.

### Example 2

### Employees of a Healthcare Provider Facility

Another example of behaviors that may be monitored using the privacy awareness tool 100 is treatments received at a healthcare provider facility by employees of the healthcare provider facility. As can be appreciated, there may be various issues concerning privacy, objectivity, liability, fraudulent behavior, and the like, when employees of a healthcare provider facility receive treatment at the facility. The privacy awareness tool 100 may utilize data in the EMR system or other systems concerning employees' positions, departments, organization charts, treatments, and the like. Rules may be established and applied to the data sets to detect instances of, for example, an employee seeing a healthcare provider within the employee's own department for a condition outside of the provider's specialty. Additionally or alternatively, the privacy awareness tool 100 may be configured to include rules for detecting situations when an employee obtains treatment or medications from a provider within the employee's own department more than a certain predetermined frequency. Once again, the rules may be weighted according to various criteria such that a single occurrence of certain actions may not trigger a review, whereas multiple occurrences in a predetermined period of time may do so. As can be appreciated, the rules may be set according to specific policies and objectives of a particular healthcare provider facility.

### Example 3

### Family Members of Employees

Another example of a behavior that may be monitored using the privacy awareness tool 100 is the treatment of family members by an employee of a healthcare provider facility. This situation may present various issues similar to the case where employees of a healthcare provider facility receive treatment therein. In this example, the privacy awareness tool 100 may utilize information in the available data sets to determine whether individuals receiving treatment are family members of the person providing the treatment or of an employee of the healthcare provider facility. The information used to make this determination may include the addresses of individuals, last names, or any other information in collected data sets that may provide an indication that individuals may be related to employees of the healthcare provider facility. For example, family members of an employee may be likely to have the same address or last name of the employee. Then, as can be appreciated, the privacy awareness tool 100 may monitor transactions or events (e.g., appointments, treatments, tests, medications, etc.) to determine whether an individual is treating a family member. In appropriate circumstances, the privacy awareness tool 100 may trigger a review of the treatment received by the family member or take other suitable action as desired.

### Computing System

FIG. 3 is a diagram of hardware and an operating environment in conjunction with which implementations of the privacy awareness tool 100 may be practiced. The description of FIG. 3 is intended to provide a brief, general description of suitable computer hardware and a suitable computing environment in which implementations may be practiced. Although not required, implementations are described in the general context of computer-executable instructions, such as program modules, being executed by a computer, such as a personal computer or the like. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, cloud computing architectures, and the like. Implementations may also be practiced in distributed computing environments where tasks are performed by remote processing devices that are linked through one or more communications networks. In a distributed computing environment, program modules may be located in both local and remote memory storage devices.

The exemplary hardware and operating environment of FIG. 3 includes a general-purpose computing device in the form of a computing device 12. The computing device 12 includes the system memory 22, a processing unit 21, and a system bus 23 that operatively couples various system components, including the system memory 22, to the processing unit 21. There may be only one or there may be more than one processing unit 21, such that the processor of computing device 12 comprises a single central-processing unit (CPU), or a plurality of processing units, commonly referred to as a parallel processing environment. The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and may include read only memory (ROM) 24 and random access memory (RAM) 25. A basic input/output system (BIOS) 26, containing the basic routines that help to transfer information between elements within the computing device 12, such as during start-up, may be stored in ROM 24. The computing device 12 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media. The computing device 12 may also include one or more other types of memory devices (e.g., flash memory storage devices, and the like).

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, USB drives, and the like) accessible by the processing unit 21 may be considered components of the system memory 22.

A number of program modules may be stored on the hard disk drive 27, magnetic disk 29, optical disk 31, ROM 24, or RAM 25, including an operating system 35, one or more application programs 36, other program modules 37 (e.g., rules generation module 108, rules application module 112, notification module 116, etc.), and program data 38 (e.g., rules storage module 104, etc.). A user may enter commands and information into the computing device 12 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus 23, but may be connected by other interfaces, such as a parallel port, game port, a universal serial bus (USB), or the like. A monitor 47 or other type of display device is also connected to the system bus 23 via an interface, such as a video adapter 48. In addition to the monitor, computers typically include other peripheral output devices (not shown), such as speakers and printers.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 9 include a local-area network (LAN) 51 and a wide-area network (WAN) 52. Such networking environments are commonplace in offices, enterprise-wide computer networks, intranets and the Internet.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

What is claimed is:

1. A computer system for use in a healthcare provider facility setting, the computer system comprising:
a rules storage module operative to store a set of rules configured to detect one or more predetermined behaviors of persons associated with the healthcare provider facility;
a rules application module operatively coupled to the rules storage module, and further operative to receive a set of audit data and apply the set of rules to the audit data to determine the presence or absence of the one or more predetermined behaviors; and
a notification module operatively coupled to the rules application module and configured to automatically generate a notification in response to receiving an indication from the rules application module that one or more of the predetermined behaviors is present.

2. The computer system of claim 1, further comprising a rules generation module coupled to the rules storage module configured to permit a user to generate the set of rules.

3. The computer system of claim 1, wherein the rules application module is configured to weight individual rules differently depending on their importance or frequency of occurrence.

4. The computer system of claim 1, wherein the rules application module is configured to combine a plurality of rules to determine the presence or absence of a single predetermined behavior.

5. The computer system of claim 1, wherein the notification generated by the notification module comprises a textual message.

6. The computer system of claim 1, wherein the notification generated by the notification module comprises a report including information regarding the audit data that caused the rules application module to determine the presence of one or more of the predetermined behaviors.

7. The computer system of claim 1, wherein the persons associated with the healthcare provider facility include employees, family members of employees, or patients.

8. The computer system of claim 1, wherein the one or more predetermined behaviors comprise fraudulent behavior or behavior that may present privacy concerns.

9. The computer system of claim 1, wherein the rules application module is operative to apply the set of rules to the audit data to generate a score, and to compare the score with a predetermined threshold to determine the presence or absence of one or more of the predetermined behaviors.

10. The computer system of claim 1, wherein the rules application module is operatively coupled to an electronic medical records (EMR) system of the healthcare provider facility.

11. The computer system of claim 1, wherein a rule in the set of rules comprises determining when a healthcare provider provides care to a patient for a condition outside the healthcare provider's specialty.

12. The computer system of claim 1, wherein a rule in the set of rules comprises determining when an employee receives care within the employee's own department of the healthcare provider facility.

13. The computer system of claim 1, wherein a rule in the set of rules comprises determining when a family member of an employee receives care at the healthcare provider facility.

14. The computer system of claim 1, wherein the audit data comprises patient data, employee data, or event data.

15. The computer system of claim 1, further comprising an archive repository module operatively coupled to the notification module and configured to aggregate information received from the notification module and to generate reports relating to the received information.

16. A method for monitoring behavior in a healthcare provider facility setting, the method comprising:
storing a set of rules configured to detect one or more predetermined behaviors of persons associated with the healthcare provider facility;
accessing a set of audit data;
applying the set of rules to the audit data to determine the presence or absence of the one or more predetermined behaviors; and
generating a notification in response to receiving an indication from the rules application module that one or more of the predetermined behaviors is present.

17. The method of claim 16, further comprising generating the set of rules dependent on input received from a user.

18. The method of claim 16, further comprising weighing individual rules differently depending on their importance or frequency of occurrence.

19. The method of claim 16, further comprising combining a plurality of rules to determine the presence or absence of a single predetermined behavior.

20. The method of claim 16, wherein generating the notification comprises generating and sending a textual message.

21. The method of claim 16, wherein generating the notification comprises generating a report including information regarding the audit data that caused the rules application module to determine the presence of one or more of the predetermined behaviors.

22. The method of claim 16, wherein the persons associated with the healthcare provider facility include employees, family members of employees, or patients.

23. The method of claim 16, wherein the one or more predetermined behaviors comprise fraudulent behavior or behavior that may present privacy concerns.

24. The method of claim 16, further comprising applying the set of rules to the audit data to generate a score, and comparing the score with a predetermined threshold to determine the presence or absence of one or more of the predetermined behaviors.

25. The method of claim 16, wherein accessing the audit data comprises accessing an electronic medical records (EMR) system of the healthcare provider facility.

26. The method of claim 16, wherein applying the set of rules comprises determining when a healthcare provider provides care to a patient for a condition outside the healthcare provider's specialty.

27. The method of claim 16, wherein applying the set of rules comprises determining when an employee receives care within the employee's own department of the healthcare provider facility.

28. The method of claim 16, wherein applying the set of rules comprises determining when a family member of an employee receives care at the healthcare provider facility.

29. The method of claim 16, wherein the audit data comprises patient data, employee data, or event data.

30. The method of claim 16, further comprising aggregating information related to the notifications and generating reports relating to the aggregated information.

31. A computer readable medium having stored thereon computer-executable instructions for performing a procedure to detect one or more predetermined behaviors of persons associated with a healthcare provider facility, the procedure comprising:
storing a set of rules configured to detect the one or more predetermined behaviors;
accessing a set of audit data;
applying the set of rules to the audit data to determine the presence or absence of the one or more predetermined behaviors; and
generating a notification in response to receiving an indication from the rules application module that one or more of the predetermined behaviors is present.
